(19) United States
(12) Patent Application Publication
(10) Pub. No.: US 2005/0136946 A1
(43) Pub. Date: Jun. 23, 2005

(54) System, method and computer program product for providing differential location services with mobile-based location tracking

(75) Inventors: Dirk Trossen, Cambridge, MA (US); Dana Pavel, Cambridge, MA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/738,635

(22) Filed: Dec. 17, 2003

(51) Int. Cl. H04Q 7/20; H04M 11/00

(52) U.S. Cl. 455/456.2; 455/456.1

(57) ABSTRACT

A system for providing differential location service includes a service provider capable of receiving a request for a differential location service that includes a geographic area defined independent of a specific format. The service provider is capable of receiving the request such that the geographic area can be transformed to thereby define the geographic area in a predetermined manner. The system can include a tracking entity capable of sending the request. The system can additionally, or alternatively, include a network entity (e.g., service provider or a tracked entity) capable of entering a subscription including the geographic area defined in the predetermined manner such that the tracking entity has exclusive access rights to modify the subscription. The network entity can also determine whether to provide the requested differential location service based upon a current location of the tracked entity located remote from the tracking entity, and upon the subscription.

### FIELD OF THE INVENTION

The present invention relates generally to systems and methods for providing location information regarding a terminal and, more particularly, relates to systems, methods and computer program products for providing differential location services to a tracking entity that tracks a tracked entity's location, wherein the differential location services are provided based upon the location of the tracked entity.

### BACKGROUND OF THE INVENTION

In many wireless communication networks and other mobile networks, the network keeps track of the location of mobile stations, such as mobile telephones, at least on a cell level. In such networks, it is typically also possible to determine the geographic location of the mobile stations, and provide services based upon the location of the mobile stations. For example, IN-based solutions have been implemented, triggering certain Intelligent Network (IN) functionality, such as call forwarding or call barring, based on the location information of a mobile station, and thus the mobile subscriber. Also in current systems implementing the Global System for Mobile Communications (GSM) standard, local Short Messaging Service (SMS) messages can be provided based on the current location of a subscribing mobile station.

In various applications, service announcements can be transmitted to mobile stations on the basis of a service request of a subscriber in mobile communication systems. Generally, these chargeable services are most often arranged to be provided from outside the actual mobile communication system. By making a call to a required service number or sending a request over the Internet, for example, a mobile subscriber is able to order a selected service announcement to be delivered to the display of the mobile station, for example. Of these individual services, e.g., weather forecast, traffic announcements, local news and other local services, such as taxi ordering and service station announcements and so on, are services where the mobile subscriber selects the desired announcement on the basis of the geographic area. The mobile subscriber generally wishes to have the service announcement related to his/her current location which varies because of the mobile nature of the mobile subscriber.

A special type of location-based service, often referred to as a differential location service, provides functionality based on the distance of the mobile station between two or more locations. For example, when the mobile station, and thus the mobile subscriber, moves to a location exceeding a predefined distance from the location of a desired meeting location, various precautionary actions can be triggered, such as sending out “running late” messages to the attendants of a meeting at the meeting location.

Whereas current techniques are adequate for providing location services, and differential location services, such techniques have drawbacks. Among the drawbacks, current techniques are typically bound to specified operators or systems, current techniques can place an unnecessary burden on system resources, and current techniques typically to not provide for access rights distributed from the mobile station. More particularly, conventional techniques for providing location services are typically bound to specified operators or systems as such techniques rely on dedicated network functionality, such as IN signaling or cell ID information in GSM. And with the increasing importance of service provisioning in a multidimensional heterogeneity, network- and system-bound techniques for providing location services do not typically adequately provide location services across networks, operators, vendors and/or even terminals.

More particularly, location information used in providing differential location services can exist in multiple formats, e.g., expressed as GPS, cell ID, place name, RFID tag, and the like. Due to the multiplicity of location information formats, conventional network-bound services typically do not suffice for providing differential location triggers. Various mapping services, such as MapQuest or MapPoint.NET, do provide transformation of certain location information, typically addresses or place names, into GPS-like coordinates (although MapQuest provides a map output rather than coordinates). Such mapping services also support differential location information, however, they do not support arbitrary location information such as cell ID or RFids. Also, such mapping services do not provide triggering certain actions based on differential location triggers. And whereas other mapping techniques, such as those provided in cellular networks (e.g., GSM) also provide some form of mapping services, they only support cellular-specific location information, such as cell ID and the respective geographic data. They do not provide triggers, and further do not support other non-cellular location information.

In addition to being bound to specified operators or systems, current techniques for providing differential location services can place an unnecessary burden on network resources. In this regard, conventional techniques typically rely on permanently tracking location by a service provider across the network. However, such permanent tracking of the mobile station location can place a heavy burden on the network and/or providers of such differential location services, particularly when provisioning for a large number of mobile stations. Further, conventional techniques for providing differential location services typically cannot provide access rights to such services distributed from the tracked mobile station. For some applications, however, it may be desirable to distribute access rights from the tracked mobile station. Consider, for example, a parent or guardian desiring to receive a notification if a child, elderly relative or other charge leaves a particular geographic area. In such an instance, the parent or guardian may desire to track a mobile station in the possession of the child, elderly relative or other charge. And although the mobile station is in the possession of the child, elderly relative or other charge, the parent or guardian may desire to have exclusive access rights to modify the differential-location service.

### SUMMARY OF THE INVENTION

In light of the foregoing background, embodiments of the present invention provide an improved system, method and computer program product for providing differential location services. According to embodiments of the present invention, a service provider is capable of providing the differential location services based upon the location of a tracked entity (e.g., a terminal) relative to a specified geographic area. Advantageously, differential location services in accordance with embodiments of the present invention can be requested by a tracking entity other the tracked entity. In this regard, the tracking entity can request, and the service provider can provide, differential location services in a manner such that the tracking entity, as opposed to the tracked entity, has exclusive access rights to modify such services. Also, the differential location services can be implemented at the terminal to thereby reduce the burden on the network and/or service provider supporting and providing such services.

The tracking entity can request such differential location services including a specified geographic area defined in a manner independent of a specific format, which may be a format specified by the tracking entity and/or the service provider. More particularly, the specified geographic area can be defined in a manner independent from any specific access technology or location definition. In this regard, the service provider can establish a subscription that includes the specified geographic area such that the specified geographic area can be transformed to thereby define the specified geographic area in a predetermined manner (e.g., geographic (X, Y, Z) coordinates), and thereafter in a manner supported by the terminal.

According to one aspect of the present invention, a system is presented for providing differential location service. The system can include a service provider capable of receiving a request for a differential location service that includes a geographic area defined independent of a specific format. The service provider is capable of receiving the request such that the geographic area can be transformed to thereby define the geographic area in a predetermined manner. In this regard, the system can include a mapping processor capable of receiving the geographic area from the service provider, transforming the geographic area of the request to thereby define the geographic area in the predetermined manner, and thereafter sending the geographic area defined in the predetermined manner to the service provider.

The service provider is also capable of sending a subscription that includes the geographic area defined in the predetermined manner. The system also includes a tracked entity capable of receiving the subscription at least partially over a wireless link. In turn, the tracked entity is capable of determining whether to provide the requested differential location service based upon the subscription. More particularly, the tracked entity can determine whether to provide the requested differential location service by obtaining a current location of the tracked entity defined in the predetermined manner, and thereafter comparing the current location of the tracked entity defined in the predetermined manner with the geographic area defined in the predetermined manner. IN this regard, the tracked entity can obtain the current location of itself locally or remotely, such as from a location provider. Then, after comparing the current location of the tracked entity defined in the predetermined manner with the geographic area, the tracked entity can determine whether to provide the requested differential location service based upon the comparison.

In addition to the geographic area, the subscription can include any of a number of different parameters. For example, the subscription can further include a validity time to subscribe to a differential location service. In such an instance, the tracked entity can be capable of determining if the subscription is valid based upon a current time and the validity time, and be capable of providing the requested differential location service when the subscription is valid. Also, for example, the subscription can further include a trigger condition. As such, the tracked entity can be capable of providing the requested differential location service if, based upon a comparison of a current location of the tracked entity and the geographic area from the subscription, the current location of the tracked entity satisfies the trigger condition. In addition, for example, the subscription can further include an action. Then, the tracked entity can be capable of determining whether to provide the requested differential location service by determining whether to execute the action based upon the subscription.

In accordance with another aspect of the present invention, a system is presented for providing a differential location service, where the system includes a tracking entity, a service provider and a network entity. The tracking entity is capable of sending a request for a differential location service to the service provider, where the request again includes a geographic area defined independent of a specific format. The service provider, as before, is capable of receiving the request such that the geographic area can be transformed to thereby define the geographic area in a predetermined manner. The network entity, in turn, is capable of entering a subscription including the geographic area defined in the predetermined manner such that the tracking entity has exclusive access rights to modify the subscription. In addition, the network entity is capable of determining whether to provide the requested differential location service based upon a current location of a tracked entity located remote from the tracking entity, and upon the subscription. The network entity can comprise any of a number of different entities including, for example, the tracked entity or the service provider.

According to other aspects of the present invention, methods and computer program products are presented for providing a differential location service. Embodiments of the present invention therefore enable service providers to provide differential location services independent of a specified location information format, without utilizing a pre-existing, specific location service infrastructure, and with reduced burden on resources. Advantageously, and in accordance with embodiments of the present invention, the service provider bears the burden of transforming a geographic area into a format supported by the terminal, thus reducing the resources required of the terminal to receive differential location services in accordance with conventional techniques. Hence, the tracking entity can request differential location services by merely providing a geographic area in any of a number of different formats without bothering to transform the location geographic area. In addition, by permitting the tracking entity to request such differential location services, the service provider can configure the services such that the tracking entity, as opposed to the tracked entity, has exclusive access rights to modifying such services. Therefore, the system, terminal, method and computer program product of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a wireless communications system according to one embodiment of the present invention including a cellular network and a data network to which a terminal is bi-directionally coupled through wireless RF links;

FIG. 2 is a schematic block diagram of a terminal comprising a mobile station according to one embodiment of the present invention;

FIG. 3 is a control flow diagram illustrating various steps in a method of providing differential location services according to one embodiment of the present invention; and

FIG. 4 is a flow chart illustrating various steps in a method of providing differential location services according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

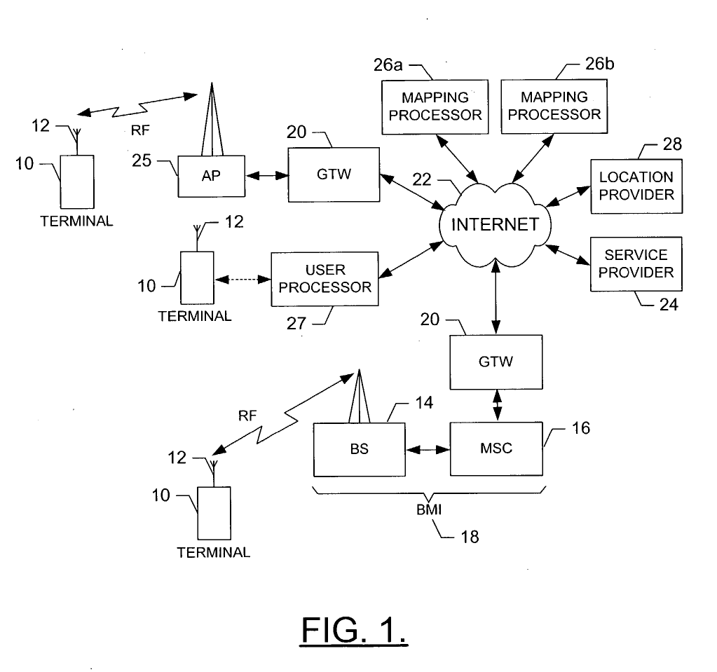

Referring to FIG. 1, an illustration of one type of terminal and system that would benefit from the present invention is provided. The system, terminal and method of the present invention will be primarily described in conjunction with mobile communications applications. It should be understood, however, that the system and method of the present invention can be utilized in conjunction with a variety of other applications, both in the mobile communications industries and outside of the mobile communications industries. For example, the system and method of the present invention can be utilized in conjunction with wireline and/or wireless network (e.g., Internet) applications including communicating in accordance with the Hypertext Transfer Protocol (HTTP).

As shown, a terminal 10 may include an antenna 12 for transmitting signals to and for receiving signals from a base site or base station (BS) 14. The base station is a part of a cellular network that includes elements required to operate the network, such as a mobile switching center (MSC) 16. As well known to those skilled in the art, the cellular network may also be referred to as a Base Station/MSC/Interworking function (BMI) 18. In operation, the MSC is capable of routing calls and messages to and from the terminal when the terminal is making and receiving calls. The MSC also provides a connection to landline trunks when the terminal is involved in a call. Further, the MSC can, but need not, be coupled to a server GTW 20 (Gateway).

The MSC 16 can be coupled to a data network, such as a local area network (LAN), a metropolitan area network (MAN), and/or a wide area network (WAN). The MSC can be coupled to the data network directly, or if the system includes a GTW 20 (as shown), the MSC can be coupled to the network via the GTW. In one typical embodiment, for example, the MSC is coupled to the GTW, and the GTW is coupled to a WAN, such as the Internet 22. In turn, devices such as processing elements (e.g., personal computers, server computers or the like) can be coupled to the terminal 10 via the Internet. For example, the processing elements can include one or more processing elements associated with a service provider 24, as well as one or more processing elements associated with one or more mapping processors 26a and 26b, and/or one or more location providers 28, one of each being illustrated in FIG. 1.

As explained below, the service provider 24 is capable of providing one or more differential location services to one or more terminals 10 based upon the current locations of the terminals relative to one or more specified geographic areas. In turn, then, the mapping processors 26a, 26b are capable of transforming the current locations and/or the specified geographic areas to define the current locations and/or specified geographic areas in a predetermined manner, such as a set of geographic (X, Y, Z) coordinates. Each mapping processor can be capable of receiving, and thereafter transforming one or more current locations and/or specified geographic areas defined in one or more different manners. As shown and described, the service provider, mapping processors and the location provider 28 are distributed from one another, such as across the Internet 22. It should be understood, however, that any one or more of the service provider, mapping processors and location provider can be logically co-located with any one or more of the service provider, mapping processor and location provider.

In addition to the service provider 24, mapping processors 26a, 26b and/or the location provider 28, the network can further be coupled to one or more wireless access points (APs) 25. The APs can comprise access points configured to communicate with the terminal in accordance techniques such as, for example, radio frequency (RF), Bluetooth (BT), infrared (IrDA) or any of a number of different wireless networking techniques, including WLAN techniques. Additionally, or alternatively, the terminal can be coupled to one or more user processors (WS) 27. Each user processor can comprise a computing system such as a personal computer, laptop computer or the like. In this regard, the user processors can be configured to communicate with the terminal in accordance with techniques such as, for example, RF, BT, IrDA or any of a number of different wireline or wireless communication techniques, including LAN and/or WLAN techniques. One or more of the user processors can additionally, or alternatively, include a removable memory capable of storing content, which can thereafter be transferred to the terminal.

The APs 25 and the workstations 27 may be coupled to the Internet 22. Like with the MSC 16, the APs and workstations can be directly coupled to the Internet. In one advantageous embodiment, however, the APs are indirectly coupled to the Internet via a GTW 20. As will be appreciated, by directly or indirectly connecting the terminals and the service provider 24, as well as any of a number of other devices, to the Internet, the terminals can communicate with one another, the service provider, etc., to thereby carry out various functions of the terminal, such as to transmit data, content or the like to, and/or receive content, data or the like from, the service provider. As used herein, the terms “data,” “content,” “information” and similar terms may be used to interchangeably to refer to data capable of being transmitted, received and/or stored in accordance with embodiments of the present invention. Thus, use of any such terms should not be taken to limit the spirit and scope of the present invention.

The service provider 24 can comprise a logical functional entity capable of providing one or more differential location services based upon the location of the respective terminal. The service provider can comprise an entity that is external to the wireless communication network, as shown in FIG. 1 (coupled to the wireless communication network via the Internet 22). Alternatively, the service provider can comprise an internal client, i.e., reside in any entity or node (including the terminal) within the wireless communication network.

Information regarding the location of the terminal 10 can be used to provide any of a number of different differential location services for any of a number of different purposes. In accordance with advantageous embodiments of the present invention, for example, a terminal, referred to herein as the “tracked entity,” can utilize the information regarding the location of the tracked entity to perform an action, such as transmitting alert messages to a “tracking entity,” when the tracked entity is located in a predefined relation with respect to a geographic area. In this regard, the tracking entity can comprise any of a number of different network components, such as the tracked entity itself, another terminal, a service provider 24, a user processor 27 or the like.

As indicated above, and explained below, to provide the location of a tracked entity (i.e., a terminal 10), the tracked entity can, but need not, be coupled to a location provider 28. In this regard, the location provider can be arranged to receive a request for location information, such as from the tracked entity. In such instances, the request for location information can include the identity of the tracked entity such as an international mobile subscriber identifier (IMSI), or a temporary identifier such as a temporary international mobile subscriber identifier (TIMSI). The location provider may respond to a location request from the tracked entity with location information for the tracked entity. The location provider may therefore provide the tracked entity, on request or periodically, the current or most recent location (if available) of the tracked entity itself or, if the location determination fails, an error indication and optionally the reason for the failure. For more information on one type of location provider, often referred to as a location server, see European telecommunications Standards Institute (ETSI) technical specification entitled: Location Services (3GPP TS23.171 and GSM 03.71), the contents of which are hereby incorporated by reference in its entirety.

The location provider 28 can be implemented in the core network and be arranged to determine the location of the tracked entity in any of a number of different manners. For example, the location provider can be capable of determining the location of the tracked entity based upon location information from the wireless communication network via the MSC 16 and/or a serving general packet radio service support node (SGSN) (not shown). Additionally or alternatively, for example, the location provider can determine the location of the tracked entity in accordance with any of a number of other techniques including, for example, triangulation, Global Positioning System (GPS), Assisted GPS (A-GPS), Time of Arrival (TOA), Observed Time Difference of Arrival (OTDOA) or the like, as such are well known to those skilled in the art.

The location of the tracked entity (i.e., a terminal 10) can be defined by the location provider 28 in any of a number of different manners. For example, the location can be defined as a logical location (e.g., Boston, Boston Common, Central Park, etc.). Also, for example, the location can be defined as a set of geographic (X, Y, Z) coordinates, where the geographic (X, Y, Z) coordinates may, but need not, include a Z coordinate. In addition, for example, the location can be defined as a set of geographic latitude and longitude coordinates. Further, the location can be defined by a cell ID, where the location can be defined as a cell identifier that identifies a geographic area through the coverage area of the cell (e.g., GSM cell) associated with the cell ID. As yet another example, the location may be defined by an RF identifier (RFID) (e.g., 32-bit identifier). In such instances, the location can be defined by an RFID, and may also be defined to include a name or other identifier of a provider associated with the RFID. In this regard, a location can be “tagged” by the tracked entity, as such by an RFID tag at a respective location, and thereafter recalled based upon the RFID provided by the RFID tag and the associated provider.

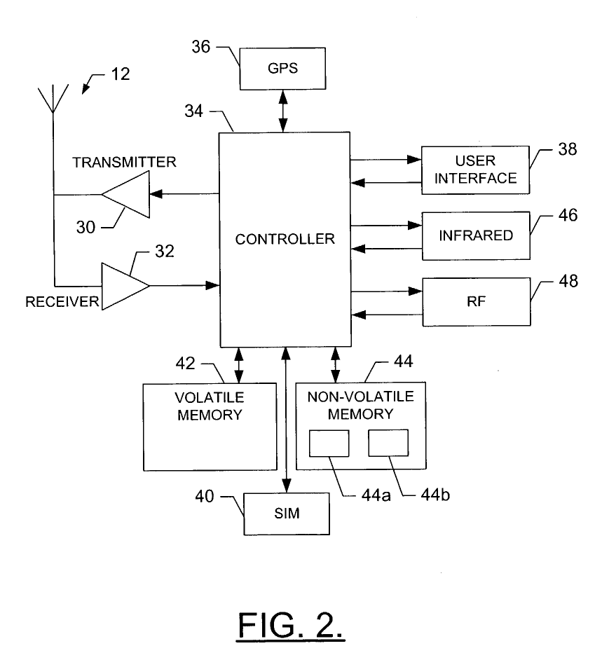

Although shown and described herein as being coupled to the Internet 22, it should be appreciated that the location provider 28 may be logically located anywhere in the data network and/or wireless communications network. Also, the location provider may be distributed between several elements of the network, or may be implemented in a single element. Further, the location provider may also be an external node to the wireless communications network. According to one embodiment, for example, the tracked entity or user equipment includes the location provider (e.g., GPS sensor 36—see FIG. 2), and thus provides the location provider functionality. In such instances, the terminal is capable of generating location information thereof.

Reference is now drawn to FIG. 2, which illustrates a block diagram of one type of terminal 10, a mobile station, that would benefit from the present invention. It should be understood, however, that the mobile station illustrated and hereinafter described is merely illustrative of one type of terminal that would benefit from the present invention and, therefore, should not be taken to limit the scope of the present invention. While several embodiments of the mobile station are illustrated and will be hereinafter described for purposes of example, other types of terminals, such as pagers, personal computers, laptop computers, personal digital assistants (PDAs) and other types of voice and text communications systems, can readily employ the present invention. In this regard, the terminal any of a number of different terminals that include a processing element or controller, and that are capable of communicating over the Internet 22 either directly or indirectly, such as via the wireless APs 25 and/or the BMI 18.

As shown, the mobile station includes a transmitter 30, a receiver 32, and a controller 34 that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first generation (1G), second generation (2G), 2.5G and/or third-generation (3G) communication protocols or the like. For example, the mobile station may be capable of operating in accordance with 2G wireless communication protocols IS-136 (TDMA), GSM, and IS-95 (CDMA). Some narrow-band AMPS (NAMPS), as well as TACS, mobile terminals may also benefit from the teaching of this invention, as should dual or higher mode phones (e.g., digital/analog or TDMA/CDMA/analog phones).

It is understood that the controller 34 includes the circuitry required for implementing the audio and logic functions of the mobile station. For example, the controller may be comprised of a digital signal processor device, a microprocessor device, and various analog to digital converters, digital to analog converters, and other support circuits. The control and signal processing functions of the mobile station are allocated between these devices according to their respective capabilities. Further, the controller may include the functionally to operate one or more software programs, which may be stored in memory (described below). For example, the controller may be capable of operating a connectivity program, such as a conventional Web browser. The connectivity program may then allow the mobile station to transmit and receive Web content, such as according to HTTP, for example. Also, for example, the controller may be capable of operating a location services client that allows the mobile station to request, and thereafter, receive services based upon the location of the mobile station, as described in more detail below.

The mobile station also comprises a user interface 38 that may include a conventional earphone or speaker, a ringer, a microphone, a display, and a user input interface, all of which are coupled to the controller 34. The user input interface, which allows the mobile station to receive data, can comprise any of a number of devices allowing the mobile station to receive data, such as a keypad, a touch display (not shown) or other input device. In embodiments including a keypad, the keypad includes the conventional numeric (0-9) and related keys (#, *), and other keys used for operating the mobile station. In addition, the mobile station can include a positioning sensor, such as a global positioning system (GPS) sensor 36. In this regard, the GPS sensor is capable of determining a location of the mobile station, such as longitudinal and latitudinal directions of the mobile station.

The mobile station can also include memory, such as a subscriber identity module (SIM) 40, a removable user identity module (R-UIM) or the like, which typically stores information elements related to a mobile subscriber. In addition to the SIM, the mobile station can include other memory. In this regard, the mobile station can include volatile memory 42, such as volatile Random Access Memory (RAM) including a cache area for the temporary storage of data. The mobile station can also include other non-volatile memory 44, which can be embedded and/or may be removable. The memories can store any of a number of pieces of information, and data, used by the mobile station to implement the functions of the mobile station. For example, the memories can include an identifier, such as an international mobile equipment identification (IMEI) code, capable of uniquely identifying the mobile station, such as to the MSC 16. Also, for example, the memories can store one or more subscriptions 44a for one or more proximity-based services, as well as a client application 44b capable of performing one or more operations based upon such subscriptions, as described below.

The mobile station can further include an infrared transceiver 46 or another local data transfer device so that data can be shared with and/or obtained from other devices such as other mobile stations, car guidance systems, personal computers, printers, printed materials including barcodes and the like. The sharing of data, as well as the remote sharing of data, can also be provided according to a number of different techniques. For example, the mobile station may include a radio frequency (RF) transceiver 48 capable of sharing data with other radio frequency transceivers, and/or with a Radio Frequency Identification (RFID) transponder tag, as such is known to those skilled in the art. Additionally, or alternatively, the mobile station may share data using Bluetooth brand wireless technology developed by the Bluetooth Special Interest Group. Further, although not shown, the mobile station may include a barcode reader such that the mobile station may receive data according to barcode data transfer techniques.

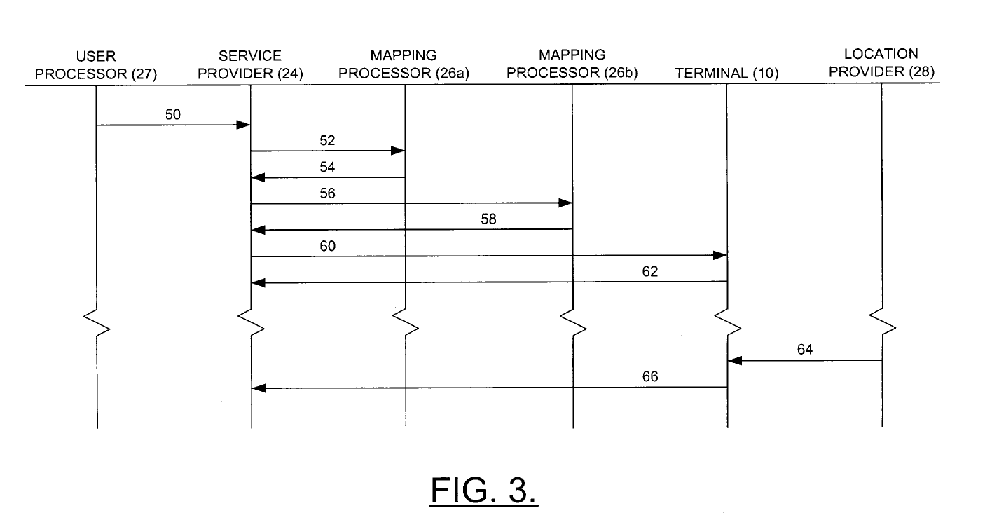

As indicated in the background section, conventional techniques for providing location services are typically bound to specified operators or systems, can place an unnecessary burden on network resources and providers of such services, and typically do not provide for access rights distributed from the tracked entity. In order to address the shortcomings of these conventional approaches, reference is now made to FIG. 3, which illustrates a control flow diagram according to exemplar methods of providing location information in the context of delivering location-based services. Advantageously, according to embodiments of the present invention, a service provider can be capable of providing location services, such as differential location services, independent of a specified location information format, and without utilizing a pre-existing, specified location service infrastructure.

Also, according to embodiments of the present invention, differential location services can be implemented at a tracked entity (e.g., terminal). As such, embodiments of the present invention can reduce the burden on the network resources and service provider in supporting and providing such services. Further, differential location services in accordance with embodiments of the present invention can be requested by a tracking entity other the tracked entity. In this regard, the tracking entity can request, and the service provider can provide, differential location services in a manner such that the tracking entity, as opposed to the tracked entity, has exclusive access rights to modifying such services. As described below, the tracked entity comprises a terminal 10, and the tracking entity comprises a user processor 27. It should be again understood, however, that the tracking entity can equally comprise any of a number of other network components, including the tracked entity itself, a service provider 24 and another terminal, without departing from the spirit and scope of the present invention.

According to the embodiment of the present invention shown in FIG. 3, a method of providing a differential location service begins with the user processor 27 (i.e., tracking entity) requesting a differential location service from a service provider 24. By permitting the user processor to request a differential location service, the service provider can configure the differential location service such that the user processor has exclusive access rights to modifying such differential location service, if so desired. To request the differential location service according to this embodiment, the user processor can send a request 50 to the service provider. The request can be sent to the service provider in any of a number of different manners. For example, the request can be sent at the conclusion of a Web-based interaction between the user processor and the service provider (via, e.g., a Web site operated by the service provider). Alternatively, for example, the request can be sent as a request message, such as an e-mail request message. The request can also include one or more requests for one or more differential location services.

The request 50 can include any of a number of different pieces of information, but in one embodiment, the request identifies a terminal 10 (i.e., tracked entity) and includes an action, a trigger, a geographic area and a validity time. In the request, the tracked entity identifies the terminal the user processor 27 (i.e., tracking entity) desires to track. In this regard, the terminal can be identified in any of a number of different manners including, for example, an IMSI, TIMSI or the like. The action defines an action capable of being executed by the terminal or more particularly, for example, a client application (e.g., client application 44b) operating on the terminal. In this regard, the action can comprise any of a number of different actions. For example, as explained below, the action can comprise sending a message to the user processor and/or one or more specified receivers.

The trigger in the request 50 typically defines one or more conditions that must be satisfied for the terminal 10 to execute the defined action. The trigger can define any of a number of different trigger conditions. In one advantageous embodiment, for example, the trigger defines a location of the terminal relative to a geographic area, which can be defined by the geographic area included in the request. For example, the trigger can specify “inside” or “outside.” In such instances, the trigger “inside” specifies a condition that is satisfied when the terminal is located inside the specified geographic area, while the trigger “outside” defines a condition that is satisfied when the terminal is located outside the specified geographic area.

The geographic area specified in the request 50 typically defines a geographic area that the terminal 10 (i.e., tracked entity) or, more particularly, the client application (e.g., client application 44b) operating on the terminal, can compare with the location of the terminal 10, such as to determine whether the location of the terminal satisfies the specified trigger condition. The geographic area can be defined in any of a number of different manners. For example, the geographic area can be defined as a location and an area relative to the location. In this regard, the location can be defined in any of a number of different manners, such as in any of the different manners of defining the location of the terminal 10 described above (logical area, geographic coordinates, cell ID, RFID, etc.). Like the location, the area relative to the location can be defined in any of a number of different manners capable of defining a geographic area. For example, the area can be defined as a radius from the location (e.g., five mile radius), and/or a distance from the location (e.g., ΔX, ΔY and/or ΔZ; Δ-longitude and/or Δ-latitude, etc.).

As may also be specified in the request 50, the validity time comprises a condition including one or more times, and/or one or more periods of time, at which, or within which, the terminal 10 can compare the location of itself with the specified geographic area to determine if the location of the terminal satisfies the specified trigger. The validity time can be specified in any of a number of different formats, such as in accordance with the iCalendar specification, as such is well known to those skilled in the art. The validity time can also be defined in any of a number of different manners, such as by one or more absolute or relative times/periods of time along with one or more defined dates. For example, the validity time can be specified as the absolute time/date “1:45 pm today.” Also, for example, the validity time can be specified as the absolute period of time/date “2:00 pm to 3:00 pm today.” As will be appreciated, in instances in which the validity time includes a period of time, the period of time can, but need not, specify a time increment (e.g., 20 minute increments) over the period of time.

In instances in which the validity time includes more than one time and/or period of time, the validity time can be defined as a number of individual times and/or periods of time with each including an associated date, or as a single time and/or period of time with a number of dates. For example, the validity time can be specified as the absolute times, “1:00 pm Monday, 1:00 pm Tuesday, and 1:00 pm Wednesday,” or as the absolute periods of time, “1:00 pm-2:00 pm Monday-Friday.” In addition, the validity time can be defined as an individual time and/or period of time that includes a periodicity. For example, the validity time can be specified as “1:45 each Monday,” or as “1:00 pm-2:00 pm each Monday.”

As will also be appreciated, in addition to one or more times and/or periods of time, the validity time may also include one or more ending delimiters, particularly in instances in which the validity time includes more than one time and/or period of time. The ending delimiters, like the times/periods of time, can be defined in any of a number of different manners, such as by one or more absolute or relative delimiters. In this regard, an ending delimiter can specify a specific number of times and/or periods of time, a unit of time including one or more times and/or periods of time (e.g., hour, day, week, month, year, etc.) or the like. For example, the validity time can be specified as “1:45 pm each Monday×4,” or as “1:45 pm each Monday in April.” In the preceding examples, “1:45 pm” defines an absolute time, “each Monday” defines a periodicity, “×4” defines a delimiter that specifies four Mondays beginning with the current date, and “in April” defines a delimiter that specifies the month of April.

In addition to, or in lieu of, specifying a specific number of times and/or periods of time, an ending delimiter can specify a condition that, when satisfied, provides an end to the validity time. The condition can comprise any of a number of different conditions capable of being interpreted by, or communicated to, the terminal 10. For example, the validity time can be specified as “1:00 pm-3:00 pm in 20 minute increments until action executed.” In the preceding example, “1:00 pm-2:00 pm defines a period of time, and “in 20 minute increments” defines an increment over the period of time. Also in the preceding example, “until action executed” defines a condition specifying that the validity time ends when the terminal executes the specified action in the request.

Irrespective of the information provided in the request 50, once the service provider 24 receives the request, the service provider can send a subscription to the terminal 10 (i.e., tracked entity) based upon the request such that the terminal or, more particularly, the client application (e.g., client application 46b) operating on the terminal, can operate in accordance with the subscription. In this regard, the subscription can include the information (i.e., subscription information) included in the request. Before the service provider can send the subscription, however, the service provider may be required to transform the specified geographic area, including the location and possibly the area relative to the location that may collectively define the geographic area. In this regard, the service provider may be required to transform the geographic area to thereby define the geographic area in a manner that permits the terminal to subsequently compare the location of the terminal with the geographic area, as described below. In one advantageous embodiment, however, the service provider can first transform the geographic area into a set of geographic (X, Y, Z) coordinates, unless the request 50 already defined the geographic area as a set of geographic (X, Y, Z) coordinates. Hence, if the request message defined a geographic area in a manner other than geographic (X, Y, Z) coordinates, the service provider can initiate a transformation of the specified geographic area.

The service provider 24 can initiate transformation of the geographic area in any of a number of different manners. According to one advantageous embodiment, for example, the service provider initiates transformation by communicating with a mapping processor 26. More particularly, the service provider can send a first transformation request 52 to the mapping processor, where the first transformation request includes the geographic area as defined in the request 50. The service provider can send the first transformation request to any of a number of different mapping processors. In one embodiment, however, the service provider is capable of selecting a mapping processor (e.g., mapping processor 26a) based upon the manner the request defines the geographic area, and thereafter sending the first transformation request to the respective mapping processor.

After receiving the first transformation request 52, the mapping processor 26 (e.g., napping processor 26a) can transform the geographic area into (X, Y, Z) coordinates. The mapping processor can then return the transformed geographic area to the service provider 24, such as in a response 54. As will be appreciated, the first transformation request and response can be formatted in any of a number of different manners, such as in accordance with ICMP (Internet Control Message Protocol), UDP (User Datagram Protocol) or SOAP (Simple Object Access Protocol). Also, the information in the first transformation request and response can be formatted in any of a number of different manners, such as in accordance with Resource Description Framework (RDF) or XML (Extensible Markup Language).

After receiving the geographic area defined as a set of geographic (X, Y, Z) coordinates (whether from the user processor 27 in the request 50 or from the mapping processor 26 in the response 54), the service provider 24 can, if necessary, further transform the geographic area, defined as a set of geographic (X, Y, Z) coordinates, to thereby define the geographic area in a manner that permits the terminal 10 (i.e., tracked entity) to subsequently compare the location of the terminal with the geographic area. In this regard, the terminal may support any of a number of different formats of the geographic area including, for example, the location defined as a logical area, set of geographic coordinates, cell ID, RFID or the like, and the area relative to the location defined as a radius, distance or the like.

The service provider 24 can identify the format of the geographic area supported by the terminal 10 in any of a number of different manners. For example, the service provider can identify the respective format from previous communication with the terminal, such as in the same manner as the service provider receives the request 50 from the user processor 27 (i.e., tracking entity). More particularly, for example, the terminal and service provider can communicate to establish the terminal as a tracked entity. In such an instance, the terminal can identify, to the service provider, the format of the geographic area supported by the terminal. The terminal can also authorize the user processor to enter subscriptions with the service provider to track the location of the terminal. In addition, the service provider can deliver the client application (e.g., client application 46b) to the terminal, if the terminal does not already store the client application.

As before, the service provider 24 can initiate transformation of the geographic area by communicating with a mapping processor 26. More particularly, the service provider can send a second transformation request 56 to the mapping processor, where the second transformation request includes the geographic area defined as a set of geographic (X, Y, Z) coordinates. The service provider can send the second transformation request to any of a number of different mapping processors. In one embodiment, however, the service provider is capable of selecting a mapping processor (e.g., mapping processor 26b) based upon the manner or format of the geographic area supported by the terminal, and thereafter sending the transformation request to the respective mapping processor.

After receiving the second transformation request 56, the mapping processor 26 (e.g., mapping processor 26b) can transform the geographic area from a set of geographic (X, Y, Z) coordinates to a format supported by the terminal 10. The mapping processor can then return the transformed geographic area to the service provider 24, such as in a response 58. Like the first transformation request and response, the second transformation request and response can be formatted in any of a number of different manners, such as in accordance with ICMP, UDP or SOAP. Also, the information in the second transformation request and response can be formatted in any of a number of different manners, such as in accordance with RDF or XML.

As will be appreciated, the mapping processor 26 transforming the geographic area defined in the request 50 into a set of geographic (X, Y, Z) coordinates can comprise the same or a different mapping processor transforming the geographic area defined as a set of geographic (X, Y, Z) coordinates into a format supported by the terminal 10 (i.e., tracked entity). In this regard, when a single mapping processor performs both transformations, the mapping processor can receive the first transformation request 52 and respond with the geographic area in a format supported by the terminal, without requiring the service provider to send the second transformation request 56. Alternatively, the service provider 24 can be capable of performing both transformations without sending either the first or the second transformation request.

Irrespective of the manner in which the geographic area is transformed, after the service provider 24 receives the geographic area in a format supported by the terminal 10 (i.e., tracked entity), the service provider can send a subscription to the terminal, such as in a subscription message 60. More particularly, the service provider can send a subscription to the client application (e.g., client application 46b) operating on the terminal, based upon the request 50, where the subscription can include the information (i.e., subscription information) included in the request and the geographic area defined in a format supported by the terminal.

Before the service provider 24 sends the subscription to the client application, however, the service provider can verify that the user processor 27 has authorization to request tracking of the terminal 10. In this regard, such authorization can be obtained in any of a number of different manners, such as from the terminal sending an authorization to the service provider at a prior point in time, such as at the time that the terminal is initially established as a tracked entity, or in response to an inquiry by the service provider. In addition, before sending the subscription, the service provider can protect the subscription including the subscription information such that the subscription cannot be subsequently disabled and/or modified by unauthorized entities. For example, the service provider can protect the subscription such that a user of the user processor 27 has exclusive access rights to the subscription, such as to prevent a user of the terminal from disabling or modifying the subscription.

After receiving the subscription message 60, the client application (e.g., client application 46b) operating on the terminal 10 can enter the subscription. Thereafter, the terminal, or the client application operating on the terminal, can send an accept message 62 to the service provider 24 notifying the service provider that the terminal has accepted the entered subscription, where the accept response can, but need not, include a subscription identifier associated with the respective subscription.

Advantageously, and in accordance with embodiments of the present invention, after entering the subscription, the client application (e.g., client application 46b) of the terminal 10 (i.e., tracked entity) can compare the location of the terminal with the specified geographic area in accordance with the specified validity time. By comparing the location of the terminal with the specified area, the client application can determine when to provide the respective differential location service to the user processor 27. As will be appreciated, before comparing the location of the terminal with the geographic area, the client application can receive the location of the terminal, such as from the terminal itself and/or from the location provider 28. Then, based upon the comparison, the client application can execute the specified action if the location of the terminal satisfies the specified trigger.

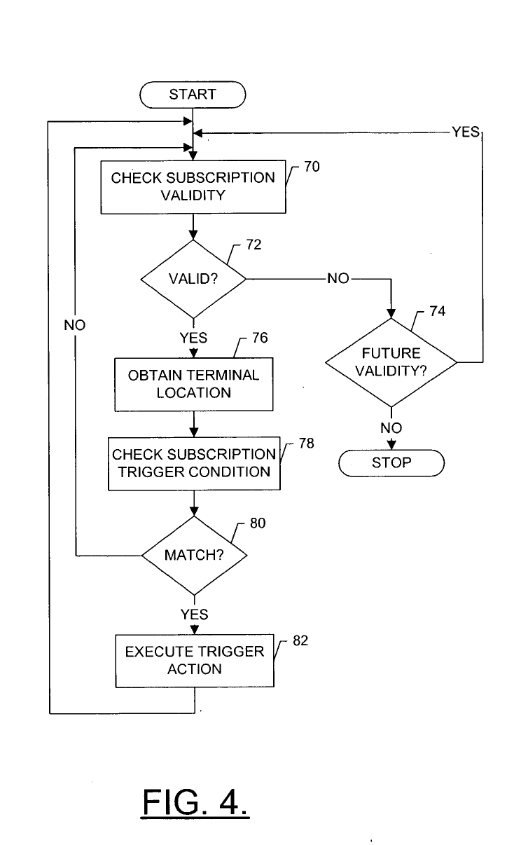

More particularly, referring to FIG. 4, after entering the subscription, the client application (e.g., client application 46b) of the terminal 10 can check the validity time of the subscription against the current time/date to thereby determine if the subscription is valid for the current time, as shown in blocks 70 and 72. For example, when the validity time is defined by a specific time/date, the client application can check to determine if the current time/date matches the specific time/date. Also for example, when the validity time is defined by a specific period of time, the client application can check to determine if the current time/date is within the specific period of time. If the client application determines that the subscription is not valid for the current time, the client application can determine if the subscription has any future validity, as shown in block 74. And if the subscription does have any future validity, the client application can continue to check the validity time. If the subscription does not have any future validity, however, the client application can cease to operate in accordance with the subscription, and can delete the subscription information, if so desired.

As shown in block 76, if the client application (e.g., client application 46b) of the terminal 10 determines that the subscription is valid for the current time, the client application can obtain the location of the terminal 10. The client application can obtain the location of the terminal in any of a number of different manners, such as from the terminal itself or from the location provider 28. In one advantageous embodiment, the terminal can be responsible for determining its current location, and sending the current location to the client application. In such instances, the terminal can determine its current location in any of a number of different manners. For example, the terminal can be capable of determining its current location based upon information obtained by the access technology of the terminal, such as the current cell ID. Additionally, or alternatively, the terminal can determine its current location from sources local to, or distributed from, the terminal. For example, the terminal can determine its current location from a GPS sensor (e.g., GPS sensor 36). Additionally or alternatively, for example, the terminal can determine its current location from one or more RF identifiers (described above) or the like. With the terminal tracking its own location, the client application (e.g., client application 46b) can receive the location independent of the network over which the terminal communicates. As such, the client application can operate in accordance with the subscription for differential service with reduced load on the network.

In addition to, or in lieu of, the terminal 10 determining its current location and sending its current location to the client application (e.g., client application 46b), the location provider 28 can be responsible for determining the current location. In this regard, the location provider can determine the location of the terminal, such as in accordance with any of the number of manners described above. And whereas the location provider can determine the location of the terminal without interaction with the terminal, in one advantageous embodiment, the location provider determines the location of the terminal based upon an authorization of the terminal. For example, the location provider can determine the location of the terminal in accordance with an authorization, which the client application can provide to the location provider as an authorization token in conjunction with, or separate from, the location request.

As shown in FIG. 3, irrespective of how the terminal 10 or location provider 28 determines the current location of the terminal, the terminal (or, more particularly, a controller of the terminal) and/or the location provider can provide the current location of the terminal to the client application (e.g., client application 46), such as in a location message 64. The terminal or location provider can initiate providing the location to the client application, such as by sending the location with a given periodicity or based upon changes in the location of the terminal. Additionally, or alternatively, the client application can initiate reception of the location message, such as by sending a location request to the terminal or location provider when the client application determines the subscription is valid.

Like the location specified by the geographic area in the request message 50, the current location of the terminal 10 can be defined by the location message 60 in any of a number of different manners supported by the terminal, which due to the transformation at the service provider 24, is typically in the same format as the geographic area in the subscription. If the location of the terminal is defined by the location message in a format not supported by the terminal, however, the client application (e.g., client application 46b) can initiate a transformation of the current location. The client application can initiate transformation of the current location information in any of a number of different manners. In one advantageous embodiment, however, the client application sends a transformation request to an appropriate mapping processor, which can thereafter respond by returning the location transformed into a format consistent with the format of the geographic location in the subscription.

Again referring to FIG. 4, after obtaining the location of the terminal 10, the client application (e.g., client application 46b) of the terminal can compare the location of the terminal with the geographic area to check if the location of the terminal satisfies the trigger condition specified in the subscription information, as shown in block 78. For example, if the trigger specifies the location of the terminal “outside” the specified geographic area, the client application can compare the location of the terminal with the geographic area to determine whether the terminal is located outside the geographic area.

As shown in block 78, if the location of the terminal 10 does not satisfy the specified trigger, the client application (e.g., client application 46b) of the terminal can again check the validity of the subscription, and if the subscription is valid for the current time, obtain the location of the terminal and compare the location of the terminal with the specified geographic area to determine if the location of the terminal satisfies the trigger condition. If, on the other hand, the location of the terminal does satisfy the specified trigger, the client application can perform the action specified in the subscription information, as shown in block 82. Thereafter, the method can repeat, typically beginning with the client application again checking the validity of the subscription (see block 70). This process is typically repeated until the subscription is no longer valid, as noted above.

As an example of one application of the system and method of one embodiment of the present invention, consider a user processor 27 (i.e., tracking entity) operated by a parent desiring to track the location of a child carrying a terminal 10 (i.e., tracked entity). In such an instance, the parent desires to receive an “alert” message, such as an e-mail alert message, from the terminal if, at any of a number of periodic instances, the child is outside a specified “vicinity” of the location of the parent and child's home (as determined based upon the location of the terminal).

To direct the terminal 10 to send such alert messages, the user processor can send a request to a service provider 24. In this regard, the request can identify the terminal (i.e., tracked entity), and can include an action such as, for example, “send ‘alert’ message to user processor.” The request can also include a trigger comprising “outside,” and a geographic area specifying the location of the parent and child's home and the “vicinity.” Further, the request can include a validity time comprising an indefinite period of time, where the period of time can include a time increment, such as 10 minutes.

Upon receipt of the request from the user processor 27, the service provider 24 can send a subscription to the terminal 10 (i.e., tracked entity) that includes the subscription information in the request message. Before entering the subscription, however, the service provider may communicate with the mapping processor 26a to transform the appointment location, and possibly the “vicinity,” into a set of geographic (X, Y, Z) coordinates. Thereafter, the service provider may communicate with another mapping processor to transform the geographic area from a set of geographic (X, Y, Z) coordinates, into a format supported by the terminal.

After transforming the geographic area, the service provider 24 can send the subscription to the terminal, where the subscription includes the transformed geographic area. Thereafter, a client application (e.g., client application 46b) operating on the terminal can enter the subscription. After entering the subscription, the client application can repeatedly check the validity of the subscription based upon the current time and the validity time (i.e., indefinite). In such an instance as the validity time is indefinite, the client application can repeatedly obtain the location of the terminal, as the subscription remains valid indefinitely. If the validity time further includes a time increment, however, the client application can repeatedly obtain the location of the terminal in accordance with the time increment. Upon obtaining the location of the terminal, as explained above, the client application can, if necessary, communicate with a mapping processor 26 to transform the location of the terminal into a format supported by the terminal.

After obtaining the location of the terminal 10, and transforming the location if necessary, the client application (e.g., client application 46b) can compare the location of the terminal with the geographic area (defined by the location of the child and parent's home and “vicinity”) to check if the terminal is located “outside” the “vicinity” of the respective location. Then, if the terminal is located “outside” the “vicinity,” the trigger condition is satisfied, and the client application can send the alert message to the user processor 27. After sending the alert message, or if the terminal is not located “outside” the “vicinity” (i.e., the terminal is located inside the “vicinity” of the location of the parent and child's home), the client application can again check the validity time, with the technique continuing indefinitely.

As shown and described above, the location of the terminal and the geographic area can be defined in any of a number of different manners. As will be appreciated, according to advantageous embodiments of the present invention, the location of the terminal and the geographic area can be provided to the client application and service provider 24 independent of a specific definition. As also shown and described above, the mapping processor 26 is capable of transforming the location of the terminal and/or the geographic area into sets of geographic (X, Y, Z) coordinates. It should be understood, however, that the mapping processor need not transform the location of the terminal and/or the geographic area into geographic (X, Y, Z) coordinates. In this regard, the mapping processor can be capable of transforming the location of the terminal and/or the geographic area into any definition of the same that permits the client application to compare the location of the terminal with the geographic area. For example, the mapping processor can transform the location information into latitude and longitude coordinates.

As also shown and described above, the service provider 24 sends a subscription to the terminal, where a client application (e.g., client application 46b) of the terminal operates in accordance with the subscription to perform an action included in the subscription. It should be understood, however, that the service provider can alternatively enter the subscription and operate in accordance with the subscription to perform the action, such as in the manner shown in FIG. 4. For example, the service provider can communicate with a mapping processor 26 to transform the geographic area into a set of geographic (X, Y, Z) coordinates, for example. Thereafter, the service provider can receive the current location of the terminal in accordance with the subscription, and if the location is in a format other than geographic (X, Y, Z) coordinates, the service provider can communicate with the same or another mapping processor to transform the location into a set of geographic (X, Y, Z) coordinates. The service provider can then determine whether to provide the differential location service based upon a comparison of the geographic area and the current location of the terminal. For more information on the service provider operating in accordance with a subscription, see U.S. patent application Ser. No. ______, entitled: System and Method for Providing Differential Location Services, filed Sep. 17, 2003, the contents of which are hereby incorporated by reference in its entirety.

Embodiments of the present invention therefore enable service providers to provide differential location services independent of a specified location information format, and with reduced burden on resources. Advantageously, as the service provider bears the burden of transforming a geographic area into a format supported by the terminal, the resources required of the terminal to receive differential location services can be reduced as compared to conventional techniques. Hence, the tracking entity can request differential location services by merely providing a geographic area in any of a number of different formats without bothering to transform the location geographic area. In addition, by permitting the tracking entity to request such differential location services, the service provider can configure the services such that the tracking entity, as opposed to the tracked entity, has exclusive access rights to modifying such services.

According to various embodiments of the present invention, the system, terminal 10, service provider 24, mapping processor 26 and/or location provider 28 of embodiments of the present invention generally operate under control of a computer program product (e.g., client application 46). The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIGS. 3 and 4 are a control flow diagram and flowchart of a method, system and program product according to embodiments of the invention. It will be understood that each block or step of the flow diagram and flowchart, and combinations of blocks or steps in the flow diagram and flowchart, can be implemented by computer program instructions. These computer program instructions may be loaded onto a computer or other programmable apparatus, such as the terminal 10, to produce a machine, such that the instructions which execute on the computer or other programmable apparatus create means for implementing the functions specified in the flow diagram and flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flow diagram and flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flow diagram and flowchart block(s) or step(s).

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A system for providing a differential location service, the system comprising:
a service provider capable of receiving a request for a differential location service that includes a geographic area defined independent of a specific format, wherein the service provider is capable of receiving the request such that the geographic area can be transformed to thereby define the geographic area in a predetermined manner, and wherein the service provider is also capable of sending a subscription that includes the geographic area defined in the predetermined manner; and
a tracked entity capable of receiving the subscription at least partially over a wireless link, wherein the tracked entity is capable of determining whether to provide the requested differential location service based upon the subscription.

2. A system according to claim 1, wherein the tracked entity is capable of obtaining a current location of the tracked entity defined in the predetermined manner, wherein the tracked entity is then capable of comparing the current location of the tracked entity defined in the predetermined manner with the geographic area defined in the predetermined manner, and thereafter determining whether to provide the requested differential location service based upon the comparison.

3. A system according to claim 2, wherein the tracked entity is capable of obtaining the current location local at the tracked entity.

4. A system according to claim 2 further comprising:
a location provider located remote from the tracked entity and capable of determining a current location of the tracked entity,
wherein the tracked entity is capable of obtaining the current location from the location provider.

5. A system according to claim 1, wherein the subscription further includes a validity time to subscribe to a differential location service, and wherein the tracked entity is capable of determining if the subscription is valid based upon a current time and the validity time, and capable of providing the requested differential location service when the subscription is valid.

6. A system according to claim 1, wherein the subscription further includes a trigger condition, and wherein the tracked entity is capable of providing the requested differential location service if, based upon a comparison of a current location of the tracked entity and the geographic area from the subscription, the current location of the tracked entity satisfies the trigger condition.

7. A system according to claim 1, wherein the subscription further includes an action, and wherein the tracked entity is capable of determining whether to provide the requested differential location service by determining whether to execute the action based upon the subscription.

8. A system according to claim 1 further comprising:
a tracking entity capable of sending the request for a differential location service to the service provider, wherein the tracking entity is located remote from the tracked entity, and wherein the tracking entity has exclusive access rights to modify the subscription.

9. A system according to claim 1 further comprising:
a mapping processor capable of receiving the geographic area from the service provider, wherein the mapping processor is capable of transforming the geographic area of the request to thereby define the geographic area in a predetermined manner, and thereafter sending the geographic area defined in the predetermined manner to the service provider.

10. A system for providing a differential location service, the system comprising:
a tracking entity capable of sending a request for a differential location service, the request including a geographic area defined independent of a specific format;
a service provider capable of receiving the request such that the geographic area can be transformed to thereby define the geographic area in a predetermined manner; and
a network entity capable of entering a subscription including the geographic area defined in the predetermined manner such that the tracking entity has exclusive access rights to modify the subscription, wherein the network entity is also capable of determining whether to provide the requested differential location service based upon a current location of a tracked entity located remote from the tracking entity, and upon the subscription.

11. A system according to claim 10, wherein the network entity is capable of obtaining a current location of the tracked entity defined in the predetermined manner, and wherein the network entity is capable of comparing the current location of the tracked entity defined in the predetermined manner with the geographic area defined in the predetermined manner from the subscription, and thereafter determining whether to provide the requested differential location service based upon the comparison.

12. A system according to claim 11, wherein the network entity is capable of obtaining the current location local at the network entity.

13. A system according to claim 11 further comprising:
a location provider located remote from the network entity and capable of determining a current location of the tracked entity,
wherein the network entity is capable of obtaining the current location from the location provider.

14. A system according to claim 10, wherein the subscription further includes a validity time to subscribe to a differential location service, and wherein the network entity is capable of determining if the subscription is valid based upon a current time and the validity time, and capable of providing the requested differential location service when the subscription is valid.

15. A system according to claim 10, wherein the subscription further includes a trigger condition, and wherein the network entity is capable of providing the requested differential location service if, based upon a comparison of a current location of the tracked entity and the geographic area from the subscription, the current location of the tracked entity satisfies the trigger condition.

16. A system according to claim 10, wherein the subscription further includes an action, and wherein the network entity is capable of determining whether to provide the requested differential location service by determining whether to execute the action based upon the subscription.

17. A system according to claim 10, wherein the service provider is capable of sending the subscription to the network entity comprising the tracked entity at least partially over a wireless link.

18. A method of providing a differential location service, the method comprising:
receiving a request for a differential location service, the request including a geographic area defined independent of a specific format;
transforming the geographic area of the request to thereby define the geographic area in a predetermined manner;
sending a subscription to a tracked entity at least partially over a wireless link, wherein the subscription includes the geographic area defined in the predetermined manner; and
entering the subscription and thereafter determining, at the tracked entity, whether to provide the requested differential location service based upon the subscription.

19. A method according to claim 18, wherein determining whether to provide the requested differential location service comprises:
obtaining a current location of the tracked entity defined in the predetermined manner;
comparing the current location of the tracked entity defined in the predetermined manner with the geographic area defined in the predetermined manner; and
determining whether to provide the requested differential location service based upon the comparison.

20. A method according to claim 19, wherein obtaining a current location comprises obtaining a current location local at the tracked entity.

21. A method according to claim 19, wherein obtaining a current location comprises obtaining a current location from a location provider located remote from the tracked entity.

22. A method according to claim 18, wherein the subscription further includes a validity time to subscribe to a differential location service, and wherein determining whether to provide the requested differential location service comprises:
determining if the subscription is valid based upon a current time and the validity time; and
providing the requested differential location service when the subscription is valid.

23. A method according to claim 18, wherein the subscription further includes a trigger condition, and wherein determining whether to provide the requested differential location service comprises providing the requested differential location service if, based upon a comparison of a current location of the tracked entity and the geographic area from the subscription, the current location of the tracked entity satisfies the trigger condition.

24. A method according to claim 18, wherein the subscription further includes an action, and wherein determining whether to provide the requested differential location service comprises determining whether to execute the action based upon the subscription.

25. A method according to claim 18, wherein receiving a request comprises receiving a request for a differential location service from a tracking entity located remote from the tracked entity, and wherein sending a subscription comprises sending a subscription such that the tracking entity has exclusive access rights to modify the subscription.

26. A method of providing a differential location service, the method comprising:
sending a request for a differential location service from a tracking entity, the request including a geographic area defined independent of a specific format;
receiving the request, and thereafter transforming the geographic area of the request to thereby define the geographic area in a predetermined manner;
entering a subscription such that the tracking entity has exclusive access rights to modify the subscription, wherein the subscription includes the geographic area defined in the predetermined manner; and
determining whether to provide the requested differential location service based upon a current location of a tracked entity located remote from the tracking entity, and upon the subscription.

27. A method according to claim 26, wherein determining whether to provide the requested differential location service comprises:
obtaining a current location of the tracked entity defined in the predetermined manner;
comparing the current location of the tracked entity defined in the predetermined manner with the geographic area defined in the predetermined manner; and
determining whether to provide the requested differential location service based upon the comparison.

28. A method according to claim 27, wherein obtaining a current location comprises obtaining a current location local at the tracked entity.

29. A method according to claim 27, wherein obtaining a current location comprises obtaining a current location from a location provider located remote from the tracked entity.

30. A method according to claim 26, wherein the subscription further includes a validity time to subscribe to a differential location service, and wherein determining whether to provide the requested differential location service comprises:
determining if the subscription is valid based upon a current time and the validity time; and
providing the requested differential location service when the subscription is valid.

31. A method according to claim 26, wherein the subscription further includes a trigger condition, and wherein determining whether to provide the requested differential location service comprises providing the requested differential location service if, based upon a comparison of a current location of the tracked entity and the geographic area from the subscription, the current location of the tracked entity satisfies the trigger condition.

32. A method according to claim 26, wherein the subscription further includes an action, and wherein determining whether to provide the requested differential location service comprises determining whether to execute the action based upon the subscription.

33. A method according to claim 26 further comprising:
sending the subscription to a tracked entity at least partially over a wireless link such that the tracked entity enters the subscription and determines whether to provide the requested differential location service.

34. A computer program product for providing a differential location service, the computer program product comprising a computer-readable storage medium having computer-readable program code portions stored therein, the computer-readable program code portions comprising:
a first executable portion for receiving a request for a differential location service, the request including a geographic area defined independent of a specific format;
a second executable portion for transforming the geographic area of the request to thereby define the geographic area in a predetermined manner;
a third executable portion for sending a subscription to a tracked entity at least partially over a wireless link, wherein the subscription includes the geographic area defined in the predetermined manner; and
a fourth executable portion for entering the subscription and thereafter determining, at the tracked entity, whether to provide the requested differential location service based upon the subscription.

35. A computer program product according to claim 34, wherein the fourth executable portion is adapted to determine whether to provide the requested differential location service by obtaining a current location of the tracked entity defined in the predetermined manner, comparing the current location of the tracked entity defined in the predetermined manner with the geographic area defined in the predetermined manner, and thereafter determining whether to provide the requested differential location service based upon the comparison.

36. A computer program product according to claim 35, wherein the fourth executable portion is adapted to obtain the current location local at the tracked entity.

37. A computer program product according to claim 35, wherein the fourth executable portion is adapted to obtain the current location from a location provider located remote from the tracked entity.

38. A computer program product according to claim 34, wherein the subscription further includes a validity time to subscribe to a differential location service, and wherein the fourth executable portion is adapted to determine whether to provide the requested differential location service by determining if the subscription is valid based upon a current time and the validity time, and thereafter providing the requested differential location service when the subscription is valid.

39. A computer program product according to claim 34, wherein the subscription further includes a trigger condition, and wherein the fourth executable portion is adapted to determine whether to provide the requested differential location service by providing the requested differential location service if, based upon a comparison of a current location of the tracked entity and the geographic area from the subscription, the current location of the tracked entity satisfies the trigger condition.

40. A computer program product according to claim 34, wherein the subscription further includes an action, and wherein the fourth executable portion is adapted to determine whether to provide the requested differential location service by determining whether to execute the action based upon the subscription.

41. A computer program product according to claim 34, wherein the first executable portion is adapted to receive a request for a differential location service from a tracking entity located remote from the tracked entity, and wherein the third executable portion is adapted to send the subscription such that the tracking entity has exclusive access rights to modify the subscription.

42. A computer program product for providing a differential location service, the computer program product comprising a computer-readable storage medium having computer-readable program code portions stored therein, the computer-readable program code portions comprising:
a first executable portion for sending a request for a differential location service from a tracking entity, the request including a geographic area defined independent of a specific format;
a second executable portion for receiving the request, and thereafter transforming the geographic area of the request to thereby define the geographic area in a predetermined manner;
a third executable portion for entering a subscription such that the tracking entity has exclusive access rights to modify the subscription, wherein the subscription includes the geographic area defined in the predetermined manner; and
a fourth executable portion for determining whether to provide the requested differential location service based upon a current location of a tracked entity located remote from the tracking entity, and upon the subscription.

43. A computer program product according to claim 42, wherein the fourth executable portion is adapted to determine whether to provide the requested differential location service by obtaining a current location of the tracked entity defined in the predetermined manner, comparing the current location of the tracked entity defined in the predetermined manner with the geographic area defined in the predetermined manner, and thereafter determining whether to provide the requested differential location service based upon the comparison.

44. A computer program product according to claim 43, wherein the fourth executable portion is adapted to obtain the current location local at the tracked entity.

45. A computer program product according to claim 43, wherein the fourth executable portion is adapted to obtain the current location from a location provider located remote from the tracked entity.

46. A computer program product according to claim 42, wherein the subscription further includes a validity time to subscribe to a differential location service, and wherein the fourth executable portion is adapted to determine whether to provide the requested differential location service by determining if the subscription is valid based upon a current time and the validity time, and thereafter providing the requested differential location service when the subscription is valid.

47. A computer program product according to claim 42, wherein the subscription further includes a trigger condition, and wherein the fourth executable portion is adapted to determine whether to provide the requested differential location service by providing the requested differential location service if, based upon a comparison of a current location of the tracked entity and the geographic area from the subscription, the current location of the tracked entity satisfies the trigger condition.

48. A computer program product according to claim 42, wherein the subscription further includes an action, and wherein the fourth executable portion is adapted to determine whether to provide the requested differential location service by determining whether to execute the action based upon the subscription.

49. A computer program product according to claim 42 further comprising:
a fifth executable portion for sending the subscription to a tracked entity at least partially over a wireless link such that the tracked entity enters the subscription and determines whether to provide the requested differential location service.
